(19) United States
(12) Patent Application Publication
(10) Pub. No.: US 2003/0223411 A1
(43) Pub. Date: Dec. 4, 2003

(54) Streaming audio/video guidance in a consumer appliance

(76) Inventor: Ramon de la Fuente, Cupertino, CA (US)

Correspondence Address: Corporate Patent Counsel, U.S. Philips Corporation, 580 White Plains Road, Tarrytown, NY, 10591, US

(21) Appl. No.: 10/158,725

(22) Filed: May 30, 2002

(51) Int. Cl. H04L 12/50

(52) U.S. Cl. 370/359; 370/410

(57) ABSTRACT

A system provides context-dependent advice and training in an audio or video form to a corresponding consumer-electronic device. Preferably, the device receives the advice and training from a server on the Internet. When the device is not in contact with the Internet, the advice and training are provided from local memory, either within the target device or within a local area network that is in contact with the consumer device. In this context, the advice and training will generally provide information related to connecting to the Internet. To facilitate ease of operation, the advice and training is provided in audio and/or video form, depending upon the rendering capabilities of consumer device, and depending upon the context and/or content of the advice and training information.

### BACKGROUND OF THE INVENTION

1. Field of the Invention

This invention relates to the field of consumer electronics, and in particular to a consumer appliance that automatically provides instructions on the use of the appliance, and/or advice on the features and benefits of the appliance, in an audio and/or video format, based on information received from the Internet.

2. Description of Related Art

Consumer appliances, such as stereo systems, televisions, home entertainment systems, recording devices, and the like are becoming increasingly more sophisticated. Such devices, for example, include multiple input and output ports for transmitting or receiving content material to and from each of a variety of other devices, and may also include one or more input/output ports that provide connectivity to home networks.

Learning to operate most high-end electronic devices to their greatest potential is often a daunting task. At times, also, learning to operate even simple devices to a mediocre level of performance can be daunting, as well, depending upon the technical expertise of the user, and/or depending upon the quality of the user's manual and other documentation provided with the device. Some devices include a ‘help’ system that can be used to learn how to use the device, or to perform diagnostics, but the help system often becomes yet-another feature of the device that the user fails to learn to use.

To assist the users of their products, some vendors offer comprehensive on-line tutorials, hypertext-based user manuals, training videos, and other applications that facilitate learning about each product's features and functions. Typically, however, the user must use a computer terminal, or a set-top box, to access this training material. Unless the consumer device and the computer or set-top box are collocated, this process typically requires the user to learn about the device at one locale, and then apply the learning to the device at another locale. Also, operating the computer to obtain the instruction while simultaneously operating the device to apply the learning introduces a discontinuity in learning that substantially reduces the effectiveness and efficiency of the learning process.

To complicate the matter further, many consumer electronic devices are configured to be upgradeable, often by merely downloading a new version of software. In addition to not fully appreciating the features and benefits of the device when it was first received, many users are unaware of subsequent features and benefits, or of possible fixes to problems that they have experienced in the past.

### BRIEF SUMMARY OF THE INVENTION

It is an object of this invention to ease the task of learning to operate a consumer-electronic device. It is a further object of this invention to provide advice regarding features and benefits available for the electronic device. It is a further object of this invention to provide an efficient and effective method of integrating the learning experience into the operation of the device. It is a further object of this invention to facilitate and encourage the upgrading of the electronic device. It is a further object of this invention to provide a relatively low cost method and system for achieving the above objects.

These objects and others are achieved by a system that provides context-dependent advice and training in an audio or video form to the corresponding consumer-electronic device. Preferably, the device receives the advice and training from a server on the Internet. When the device is not in contact with the Internet, the advice and training are provided from local memory, either within the target device or within a local area network that is in contact with the consumer device. In this context, the advice and training will generally provide information related to connecting to the Internet. To facilitate ease of operation, the advice and training is provided in audio and/or video form, depending upon the rendering capabilities of consumer device, and depending upon the context and/or content of the advice and training information.

### BRIEF DESCRIPTION OF THE DRAWINGS

The invention is explained in further detail, and by way of example, with reference to the accompanying drawings wherein:

FIG. 1 illustrates an example block diagram of an audio/video guidance system in accordance with this invention.

FIG. 2 illustrates an example flow diagram for invoking the audio/video guidance system of this invention.

Throughout the drawings, the same reference numerals indicate similar or corresponding features or functions.

### DETAILED DESCRIPTION OF THE INVENTION

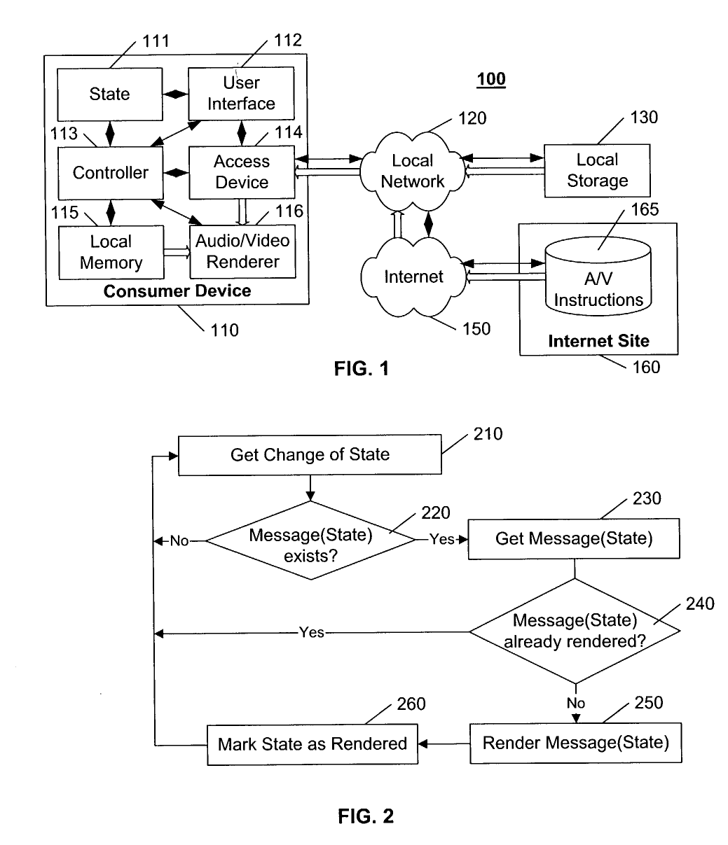

FIG. 1 illustrates an example block diagram of an audio/video guidance system 100 in accordance with this invention. The system 100 includes a consumer device 110 that is configured to connect to a local network 120, such as a local area network (LAN) or home automation network, and, from the local network 120 to the Internet 150. Optionally, the consumer device 110 may be configured to connect directly to the Internet 150, using, for example, a broadband connection, such as a cable modem, or dialup connection. The consumer device 110 may be, for example, an Internet-enabled audio system that is configured to receive online music and other entertainment material from the Internet. The Streamium MC-i200 product from Philips Electronics, for example, is a full-functioned AM/FM stereo system with CD player and MP3 recorder and player, that is also designed to connect to a home network via an Ethernet gateway router. When connected to the home network, the MC-i200 is able to receive MP3-encoded entertainment material from a Personal Computer (PC) or a file server, and, if the network provides Internet access, is able to receive entertainment material from online music services, such as Internet Radio sites, from online music collections, from online vendors, and so on.

The guidance information includes instructions for installing, operating, or maintaining the consumer device 110, and may include detailed instructions for each feature and function of the device 110, or may only include instructions for some of the more complicated or unusual features and functions. Additionally, the guidance information may include ancillary information, such as a description of the benefits that particular features provide, how best to combine features, and so on. In like manner, when the device 110 is connected to the Internet 150, the ancillary information may include advertisements for future features or functions, or notifications of corrections of faults in existing features or functions, that are available by upgrading the product. When online upgrades are provided, the guidance information will include instructions and advice regarding the any upgraded features, functions, or corrections.

In a preferred embodiment, the guidance information is distributed among storage elements 115, 130, 165, at the device 110, the local network 120, and the Internet 150, respectively, to provide economic efficiency. If detailed information is provided, for example, supplying the information from a manufacturer's Internet server 160 will generally be more efficient than incorporating the detailed information into each and every device 110 that the manufacturer produces, particularly with regard to requirements for memory to contain this information. On the other hand, guidance regarding how to connect to a local network would be incorporated into the storage 115 of each device 110, because it would be ineffective to require that the device be connected to the local network 120 or to the Internet 150 to receive this guidance from the storage elements 130, 165. If the local network 120 reliably provides access to the Internet 150, the need for storage 130 on the local network 120 is minimized, and may be eliminated.

In accordance with this invention, the guidance information is provided as audio and/or video information, depending upon the particular device 110, and the particular guidance information. For example, if the device 110 is an audio system, without a display device, the guidance information will be audio suggestions or comments. If the device 110 includes a display device, the guidance information may include instruction videos, schematic diagrams, suggested layouts, and so on. If the guidance information relates to how to display images on the display device, it will preferably be a vocal description of the process.

Also in accordance with this invention, the presentation of the guidance information is context sensitive. A controller 113 in the consumer device 110 is configured to effect the rendering of select guidance information based on a current state 111 of the consumer device 110. The state 111 of the device 110 is controlled and/or determined by the actions of a user at a user interface 112, by actions of the controller 113, and so on. The state of an audio system may correspond, for example to: power-on, connected-to-local-network, no-input-selected, surround-sound-selected, bass-enhanced, and so on. In this state, there is no need to guide the user for connecting to the local network, because the state of the device indicates that the device is already connected to the local network. In like manner, there is no need to guide the user on selecting specific tracks on a CD, because a CD has not been selected as the input to the device. It may, on the other hand, be wise to provide guidance on how to select a particular device or component for providing input to the device.

In a preferred embodiment of this invention, the controller 113 detects when the device is in a state that the device has not previously entered, and determines whether a guidance message is available for this state. The controller 1 13 is configured to initiate a search for the message at the “highest” level of the information hierarchy, and proceed downward. In the example of FIG. 1, the controller 113 will first attempt to find the message at the storage 165 of the Internet Server 160, via the access device 114. If unsuccessful, the controller 113 will next attempt to find the message at the local storage 130. If also unsuccessful, the controller 113 will next attempt to find the message within its local memory 115. In this manner, messages that are updated at the Internet server 160 can effectively replace the messages that were installed in the device 110 when it was manufactured.

If a guidance message is available, the controller 113 provides the message to the rendering component 116, but preferably only if the message has not previously been rendered, or if the user explicitly requests guidance. During the search and rendering process, if the device undergoes a change of state, the process is terminated, and the next state is evaluated. That is, for example, if a first state is entered for a brief period of time, and then exited for a second state, the need to present guidance related to the first state passes, and the controller 113 determines whether there is an as-yet-unrendered message available for this second state.

The controller 113 may also be configured to pause some minimal amount of time before rendering guidance information, to allow a user to transit to a new state. That is, in this embodiment, only if the user pauses at a particular state for more than the minimal amount of time will the message corresponding to the state be rendered.

By providing the guidance only when a user pauses at a state, and only if the same guidance has not been given in the past, the user is not inundated with messages that might cause the user to disable this feature. Not illustrated, the controller 113 provides the user the option of disabling the above described automated guidance. The controller 113 also provides the option of resetting all messages to ‘unrendered’, so that a user may reinitiate the learning process, or so that a new user may be provided with the guidance information. If the device 110 includes an option for user identification, the controller 113 is configured to maintain independent user options, including independent lists of which messages have been rendered for each user. The controller 113 also allows the user to receive guidance information on-demand, typically by entering a particular state and pressing a ‘help button’ or performing some other defined operation corresponding to a help request. In like manner, if the user upgrades the device, via, for example, a download from the Internet 150, the controller 113 is preferably configured to selectively reset or initialize messages related to the functions that are affected by the upgrade to ‘unrendered’, so that the user is provided the opportunity to receive any guidance information related to the upgraded functions or features.

FIG. 2 illustrates an example flow diagram for invoking the audio/video guidance system of this invention. At 210, a change of state is detected. This change may be caused by a user action, by the expiration of a countdown process, by termination of an action by a component associated with the consumer device, and so on. As is common in the art, certain changes of state, or certain classes of changes of state, may be defined as “don't-care” changes with regard to the guidance system.

Upon detection of a recognized change of state, the system determines whether a message for the newly-entered state exists, at 220. As noted above, preferably this determination is made in a “top-down” fashion, to allow upper-levels of the information hierarchy to substitute messages for information sources that are lower in the hierarchy. If there is no message available for guidance at this state, the system loops back to 210, to await the next recognized change of state.

At 230, the message corresponding to the state is accessed, and, at 240, the system determines whether this message has previously been rendered, and if it has been previously rendered, the system loops back to 210. A number of techniques, common in the art, may be applied to keep track of which messages have been rendered. In a straightforward embodiment, each state has an associated ‘rendered’ flag that is set when the message is first rendered. However, the use of a single flag does not facilitate the rendering of updated messages if the former message was rendered. In a more extensive tracking system, each state may have a date-time stamp associated with the last time that a message was rendered. If the date-time of the accessed message is more recent than the last rendering date-time, then this accessed message is determined to be unrendered.

If, at 240, the message is determined to be unrendered, the system renders the message via the consumer device, at 250. Preferably, this rendering is preceded by a notification signal, to catch the user's attention, and succeeded by a message-termination signal. Typically, different notification signals are provided for different events. For example, a “warning” message may have a different notification signal than an “encouragement” message. As noted above, the message rendering may be delayed, to assure that the user is purposely pausing at this state. Different delay times may be imposed, depending upon the type of message. If, for example, the system determines that a warning should be issued, because the user is about to initiate a destructive task, there may be no delay imposed. If, on the other hand, the message is merely general information regarding options that could be taken from a particular state, a much longer interrupt period is provided.

At 260, after rendering the message corresponding to the current state, the state is marked as having had a message rendered, using a flag, a date-time stamp, or other technique that is provided to minimize the rendering of redundant messages. Thereafter, the system loops back to 210, to await the next recognized change of state.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. An electronic device comprising:
a user interface that is configured to communicate user commands to the electronic device,
the user commands being communicated to affect a state of the electronic device,
a controller, operably coupled to the user interface, that is configured to determine whether a guidance message is associated with the state of the electronic device, and
a renderer, operably coupled to the controller, that is configured to render the guidance message upon command of the controller,
wherein
the guidance message includes at least one of:
an audio message, and
a video message.

2. The electronic device of claim 1, further including
an access device that is configured to access the guidance message from a remote source.

3. The electronic device of claim 2, wherein
the remote source includes a storage device that is accessed via an Internet connection.

4. The electronic device of claim 1, wherein
the controller is configured to command the renderer to render the guidance message based on whether the guidance message has previously been rendered by the renderer.

5. The electronic device of claim 4, further including
an access device that is configured to access the guidance message from a remote source.

6. The electronic device of claim 5, wherein
the remote source includes a storage device that is accessed via an Internet connection.

7. The electronic device of claim 1, wherein
the controller is configured to command the renderer to render the guidance message based on whether a predefine time duration has elapsed since the electronic device has entered the state.

8. The electronic device of claim 1, wherein
the controller is configured to command the renderer to render the guidance message based on whether the electronic device has subsequently entered an other state.

9. The electronic device of claim 1, wherein
the controller is configured to access the guidance message from one of a plurality of sources,
the plurality of sources including
a first storage element that is local to the electronic device, and
a second storage element that is remote from the electronic device, and
the controller is further configured to preferably access the guidance message from the second storage element.

10. The electronic device of claim 1, wherein
the guidance message corresponds to at least one of:
an instruction message related to at least one of:
installation, operation, and maintenance; and
an advisory message regarding at least one of:
features, benefits, options, problems, solutions, and upgrades.

11. A method of providing guidance instruction to a user of an electronic device, comprising:
determining a state of the electronic device,
determining whether a guidance message is available for the state, and
rendering the guidance message if the guidance message has not been previously rendered.

12. The method of claim 11, wherein
the guidance message includes at least one of:
an audio message, and
a video message.

13. The method of claim 12, further including
receiving the guidance message from a source that is remote from the electronic device.

14. The method of claim 12, further including
receiving the guidance message from an Internet server.

15. The method of claim 11, further including
delaying the rendering of the guidance message, and
canceling the rendering of the guidance message if the electronic device enters a new state.

16. The method of claim 11, wherein
the guidance message is one of a plurality of guidance messages located at a plurality of sources, and
the method further includes
receiving the guidance message from one of the plurality of sources based on a prioritization of the sources of the plurality of sources.

17. The method of claim 11, wherein
the guidance message corresponds to at least one of:
an instruction message related to at least one of:
installation, operation, and maintenance; and
an advisory message regarding at least one of:
features, benefits, options, problems, solutions, and upgrades.

18. The method of claim 11, wherein
determining whether the guidance message is available for the state is based on an attribute that is associated with the state, and
the method further comprising:
detecting an upgrade to the electronic device,
identifying one or more states that are affected by the upgrade, and
modifying the attribute that is associated with each of the one or more states to indicate that the guidance message has not been previously rendered.

19. A consumer device having a primary function of rendering entertainment material to a user, the consumer device including:
a user interface that is configured to receive input from the user that effects a change in a state of the consumer device, and
a controller, operably coupled to the user interface, that is configured to automatically effect a rendering of a guidance message that is associated with the state of the consumer device,
wherein
the guidance message includes at least one of:
an audio message, and
a video message.

20. The consumer device of claim 19, further including
an access device that is configured to obtain the guidance message from a source that is remote from the consumer device.

21. The consumer device of claim 19, further including
an access device that is configured to obtain the guidance message from an Internet server.

22. The consumer device of claim 21, wherein
the controller is further configured to provide an other guidance message from a memory that is local to the consumer device to facilitate a connection of the access device to the Internet server.

23. The consumer device of claim 19, wherein
the guidance message corresponds to at least one of:
an instruction message related to at least one of:
installation, operation, and maintenance; and
an advisory message regarding at least one of:
features, benefits, options, problems, solutions, and upgrades.
